(19) United States
(12) Patent Application Publication
(10) Pub. No.: US 2008/0123911 A1
(43) Pub. Date: May 29, 2008

(54) Systems and Methods for Restoring a Medical Image Affected by Nonuniform Rotational Distortion

(76) Inventors: Duc Lam, San Jose, CA (US); Shashidhar Sathyanarayana, Pleasanton, CA (US); Tat-Jin Teo, Sunnyvale, CA (US)

Correspondence Address: ORRICK HERRINGTON & SUTCLIFFE LLP, 4 PARK PLAZA, SUITE 1600, IRVINE, CA, 92614, US

(21) Appl. No.: 11/535,441

(22) Filed: Sep. 26, 2006

(51) Int. Cl. G06K 9/00

(52) U.S. Cl. 382/128

(57) ABSTRACT

The field of the invention relates to medical imaging systems, and more particularly to systems and methods for restoring a medical image affected by nonuniform rotational distortion. In one embodiment, an imaging system includes an imaging catheter having proximal and distal sections, an imaging device coupled to the distal section of the imaging catheter, said imaging device configured to rotate at a uniform angular velocity, and a processor electrically coupled to imaging device, said processor configured to generate a plurality of vectors as the imaging device rotates to form a medical image, estimate an instantaneous angular velocity of the imaging device as the imaging device rotates, and remap the plurality of vectors in the event that the estimated instantaneous angular velocity differs from the uniform angular velocity.

### FIELD OF THE INVENTION

The field of the invention relates to medical imaging systems, and more particularly to systems and methods for restoring a medical image affected by nonuniform rotational distortion.

### BACKGROUND OF THE INVENTION

For purposes of diagnosis and treatment planning, imaging techniques such as ultrasound imaging are commonly used in medical procedures to obtain images of the inside of a patient's body. In intravascular ultrasound (IVUS) imaging, images revealing the internal anatomy of blood vessels are obtained by inserting a catheter with an ultrasound transducer mounted on or near its tip into the blood vessel. The ultrasound transducer is positioned in a region of the blood vessel to be imaged, where it emits pulses of ultrasound energy. The pulses reflect off of the blood vessel wall and surrounding tissue and return back to the transducer. The reflected ultrasound energy (echo) impinging on the transducer produces an electrical signal, which is used to form an image of the blood vessel.

To obtain a cross-sectional image or “slice” of the blood vessel, the transducer must interrogate the vessel in all directions. This can be accomplished by mechanically rotating the transducer during imaging. FIG. 1 is a representation of an axial view of a rotating transducer 10 mounted on the tip of a prior art catheter 20. The transducer 10 is coupled to a drive motor (not shown) via a drive cable 30 and rotates within a sheath 35 of the catheter 20. The blood vessel 40 being imaged typically includes a blood region 45 and wall structures (blood-wall interface) 50 and the surrounding tissue.

A cross-sectional image of the blood vessel is obtained by having the transducer 10 emit a plurality of ultrasound pulses, e.g., 256, at different angles as it is rotated over one revolution. FIG. 1 illustrates one exemplary ultrasound pulse 60 being emitted from the transducer 10. The echo pulse 65 for each emitted pulse 60 received by the transducer is used to compose one radial line or “image vector” in the image of the blood vessel. Ideally, the transducer 10 is rotated at a uniform angular velocity so that the image vectors are taken at evenly spaced angles within the blood vessel 40. An image processor (not shown) assembles the image vectors acquired during one revolution of the transducer 10 into a cross-sectional image of the blood vessel 40. The image processor assembles the image vectors based on the assumption that the image vectors were taken at evenly spaced angles within the blood vessel 40, which occurs when the transducer 10 is rotated at uniform angular velocity.

Unfortunately, it is difficult to achieve and maintain a uniform angular velocity for the transducer 10. This is because the transducer 10 is mechanically coupled to a drive motor (not shown), which may be located one to two meters from the transducer, via the drive cable 30. The drive cable 30 must follow all the bends along the path of the blood vessel to reach the region of the blood vessel 40 being imaged. As a result, the drive cable 30 typically binds and/or whips around as it is rotated in the blood vessel 40. This causes the transducer 10 to rotate at a nonuniform angular velocity even though the motor rotates at a uniform angular velocity. This is a problem because the angles assumed by the image processor in assembling the image vectors into the cross-sectional image of the blood vessel 40 are different from the actual angles at which the image vectors were taken. This causes the cross-sectional image of the blood vessel to be distorted in the azimuthal direction. The resulting distortion is referred as Nonuniform Rotational Distortion (NURD).

Therefore, there is need for an image processing technique that reduces NURD in IVUS images acquired using a rotating transducer.

### SUMMARY OF THE INVENTION

The field of the invention relates to medical imaging systems, and more particularly to systems and methods for restoring a medical image affected by nonuniform rotational distortion.

In one embodiment, an imaging system includes an imaging catheter having proximal and distal sections, an imaging device coupled to the distal section of the imaging catheter, said imaging device configured to rotate at a uniform angular velocity, and a processor electrically coupled to imaging device, said processor configured to generate a plurality of vectors as the imaging device rotates to form a medical image, estimate an instantaneous angular velocity of the imaging device as the imaging device rotates, and remap the plurality of vectors in the event that the estimated instantaneous angular velocity differs from the uniform angular velocity.

In another embodiment, a process for reducing non-uniform rotational distortion in a medical image includes the steps of rotating an imaging device that is configured to rotate at a uniform angular velocity, generating a plurality of vectors that form the medical image during the rotation of the imaging device, estimating an instantaneous angular velocity of the imaging device, and remapping the plurality of vectors if the instantaneous angular velocity differs from the uniform angular velocity.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

In order to better appreciate how the above-recited and other advantages and objects of the inventions are obtained, a more particular description of the embodiments briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1 is a representation of a rotating transducer of a prior art catheter inside a blood vessel;

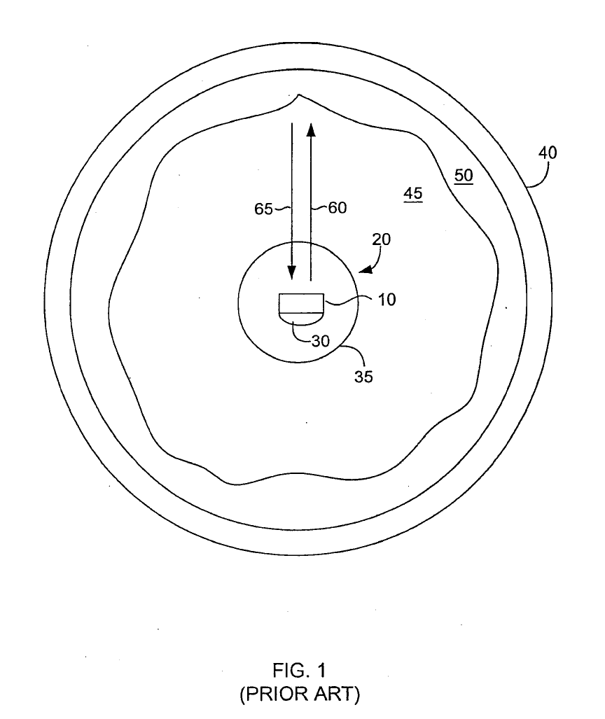

FIG. 2 is a representation of a rotating imaging device in accordance with an embodiment of the present invention; and

FIG. 3 is a diagram of a process in accordance with an embodiment of the present invention.

### DETAILED DESCRIPTION OF THE PREFERRED EMBODIMENTS

Described below is a new image processing method that reduces NURD in medical images, such as IVUS images, acquired using a rotating imaging device. In the case of a rotating imaging device, such as a transducer or light emitting device (e.g., using optical coherence tomography), at the tip of a catheter, one approach to reduce NURD is to estimate the instantaneous angular velocity of the imaging device as it rotates to determine the amount of distortion. This approach may be achieved by using a plurality of imaging devices, such as ultrasound imaging transducers. As mentioned above, other imaging devices may be used, instead of, or in addition to imaging transducers, such as apparatuses for obtaining images through optical coherence tomography (OCT). Image acquisition using OCT is described in Huang et al., “Optical Coherence Tomography,” Science, 254, Nov. 22,1991, pp 1178-1181. A type of OCT imaging device, called an optical coherence domain reflectometer (OCDR) is disclosed in Swanson U.S. Pat. No. 5,321,501, which is incorporated herein by reference. The OCDR is capable of electronically performing two- and three-dimensional image scans over an extended longitudinal or depth range with sharp focus and high resolution and sensitivity over the range.

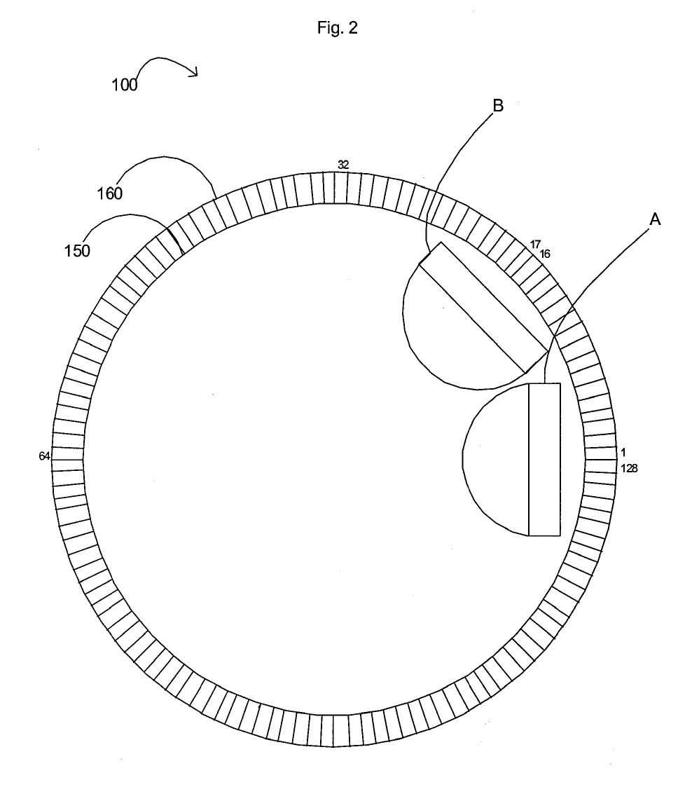

Turning to FIG. 2, an axial view of an imaging device 100 mounted on the tip of a catheter 150 is shown. The imaging device 100 includes two imaging devices A and B, illustrated as transducers in this example embodiment, positioned such that they each emit energy pulses at generally right angles to the axis of the catheter 150. Further, the imaging transducers A and B are also positioned at a 45° angle with respect to each other. In accordance with another embodiment, A and B may be positioned at any angle with respect to each other.

As mentioned above, a cross-sectional image of the blood vessel is obtained by having the imaging device 100 emit a plurality of ultrasound pulses, e.g., 256 or 128, at different angles as it is rotated over one revolution. The echo signals received from the emitted pulses are typically classified by records, or vectors, corresponding to a particular angular position in a revolution.

In FIG. 2, the imaging device 100 is overlaid onto a chart that maps 128 vectors in one revolution. In this embodiment, each transducer, A and B, generates at least 128 vectors in one revolution. During operation of the imaging device 100, in the absence of NURD, i.e., when the imaging device 100 rotates at a uniform angular velocity, as the imaging device 100 rotates, vector 1, generated by transducer A would be essentially identical to vector 17, generated by transducer B. In other words, a search of the vectors generated by transducer B would reveal that vector 17 correlates most strongly with vector 1 of transducer A.

When the imaging device 100 does not rotate at a uniform angular velocity, NURD may occur and the instantaneous angular velocity of the imaging device 100 may differ from the expected uniform angular velocity. In such a case, a search of the vectors of generated by transducer B would reveal that vector 17 no longer most strongly correctly with vector 1 of transducer A. One of ordinary skill in the art will appreciate that the discrepancy between the vector generated by transducer B that most strongly correlates with vector 1 of transducer A and the vector that would most strongly correlate with vector 1 of transducer A in the absence of NURD, e.g., vector 17, may be used to estimate the instantaneous angular velocity of the imaging device 100.

The estimated instantaneous angular velocity of the imaging device 100 may be used to remap the generated vectors to account for the discrepancy between the instantaneous angular velocity and the expected uniform angular velocity, which would, in effect, reduce the NURD in the resulting cross-sectional image. For example, if in the absence of NURD, vector 17 generated by transducer B most strongly correlates with vector 1 generated by transducer A, and if during the occurrence of NURD, vector 19 generated by transducer B most strongly correlates with vector 1 generated by transducer A, then the generated vectors that create the cross-sectional image may be remapped to account for the discrepancy between vector 17 and vector 19 generated by transducer B.

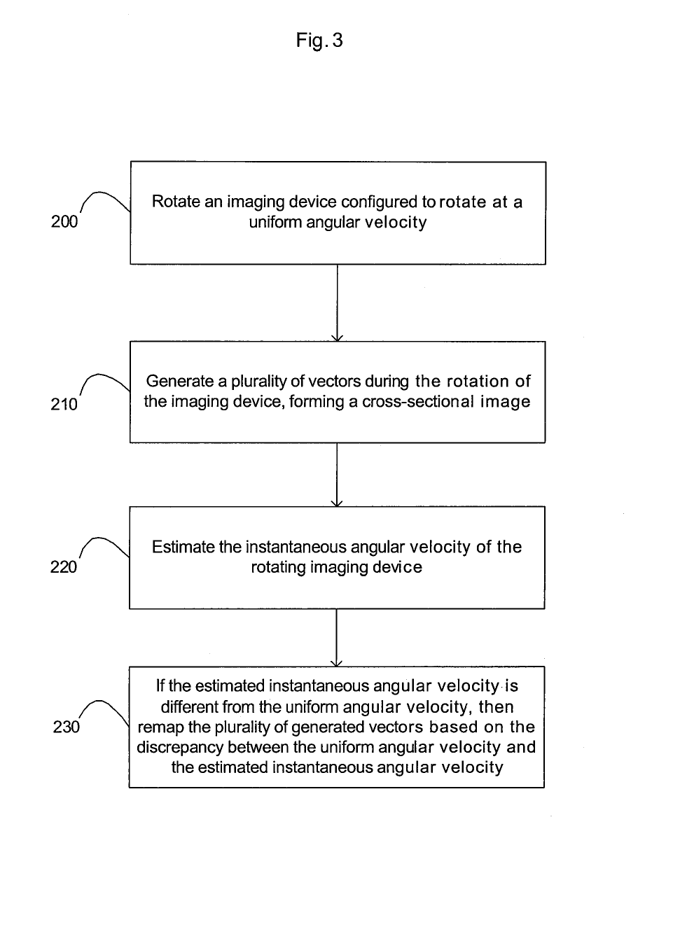

Turning to FIG. 3, a method for reducing NURD in a cross-sectional image of a lumen generated by an imaging device configured to rotate at a uniform angular velocity is shown. As the imaging device rotates (action block 200), a plurality of vectors are generated, forming the cross-sectional image (action block 210). In accordance with the method, a processor (not shown) may estimate an instantaneous angular velocity of the imaging device (action block 220). If the estimated instantaneous angular velocity differs from the uniform angular velocity, then the plurality of generated vectors may be remapped based on the discrepancy between the estimated instantaneous angular velocity and the uniform angular velocity (action block 230).

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions described herein is merely illustrative, and the invention can be performed using different or additional process actions, or a different combination or ordering of process actions. For example, this invention is particularly suited for applications involving medical imaging devices, but can be used on any design involving imaging devices in general. As a further example, each feature of one embodiment can be mixed and matched with other features shown in other embodiments. Additionally and obviously, features may be added or subtracted as desired. Accordingly, the invention is not to be restricted except in light of the attached claims and their equivalents.

What is claimed is:

1. A medical imaging system comprising:
an imaging catheter having proximal and distal sections;
an imaging device coupled to the distal section of the imaging catheter, said imaging device configured to rotate at a uniform angular velocity; and
a computer-usable medium, electrically coupled to the imaging device, having a sequence of instructions which, when executed by a processor, causes said processor to execute a process including generating a plurality of vectors as the imaging device rotates to form an image, estimating an instantaneous angular velocity of the imaging device as the imaging device rotates, and remapping the plurality of vectors whose estimated instantaneous angular velocity differs from the uniform angular velocity.

2. The medical imaging system of claim 1, wherein the imaging device comprises a plurality of imaging transducers.

3. The medical imaging system of claim 2, wherein the imaging device comprises first and second imaging transducers configured to emit energy pulses.

4. The medical imaging system of claim 3, wherein the first and second imaging transducers are positioned such that the first imaging transducer emits energy pulses at a 45 degree angle from the energy pulses emitted by the second imaging transducers.

5. The medical imaging system of claim 2, wherein the plurality of imaging transducers are ultrasound transducers.

6. The medical imaging system of claim 2, wherein each of the plurality of imaging transducers are configured to generate 256 vectors in one rotation.

7. The medical imaging system of claim 1, wherein the medical image is a cross-sectional image of a lumen.

8. The medical imaging system of claim 1, wherein the imaging system is configured to obtain a cross-sectional image of a lumen.

9. The medical imaging system of claim 2, wherein each vector generated by a first imaging transducer has a value that is substantially similar to a vector generated by a second imaging transducer.

10. The medical imaging system of claim 9, wherein the computer-usable medium has a sequence of instructions which, when executed by a processor, causes said processor to execute a process including:
determining which vector of the second imaging transducer has a value that is substantially similar to a particular vector of the first imaging transducer, and
calculating any discrepancy between the determined vector and an expected vector, wherein the expected vector is a vector of the second imaging transducer that is expected to have a value that is substantially similar to the particular vector of the first imaging transducer.

11. A method for reducing non-uniform rotational distortion in a medical image, the method comprising:
rotating an imaging device that is configured to rotate at a uniform angular velocity;
generating a plurality of vectors that form the medical image during the rotation of the imaging device;
estimating an instantaneous angular velocity of the imaging device; and
remapping the plurality of vectors if the instantaneous angular velocity differs from the uniform angular velocity.

12. The method of claim 11, wherein the imaging device comprises a plurality of imaging transducers.

13. The method of claim 11, wherein the imaging device comprises first and second imaging transducers.

14. The method of claim 13, wherein each of the first and second imaging transducers are configured to generate 256 vectors in one rotation.

15. The method of claim 13, wherein the first and second imaging transducers are position at a 45 degree angle with respect to each other.

16. The method of claim 13, wherein each of the first and second imaging transducers are configured to generate a plurality of vectors.

17. The method of claim 16, wherein each vector generated by the first imaging transducer has a value that is substantially similar to a vector generated by the second imaging transducer.

18. The method of claim 17, wherein the step of estimating the instantaneous angular velocity comprises:
determining which vector of the second imaging transducer has a value that is substantially similar to a particular vector of the first imaging transducer, and
calculating any discrepancy between the determined vector and an expected vector, wherein the expected vector is a vector of the second imaging transducer that is expected to have a value that is substantially similar to the particular vector of the first imaging transducer.

19. A system for reducing non-uniform rotational distortion in a medical image comprising:
a means for rotating an imaging device that is configured to rotate at a uniform angular velocity;
a means for generating a plurality of vectors that form the medical image during the rotation of the imaging device;
a means for estimating an instantaneous angular velocity of the imaging device; and
a means for remapping the plurality of vectors if the instantaneous angular velocity differs from the uniform angular velocity.

20. The system of claim 19, wherein the imaging device comprises a plurality of imaging transducers.

21. The system of claim 19, wherein the imaging device comprises first and second imaging transducers.

22. The system of claim 21, wherein each of the first and second imaging transducers are configured to generate 256 vectors in one rotation.

23. The system of claim 21, wherein the first and second imaging transducers are position at a 45 degree angle with respect to each other.

24. The system of claim 21, wherein each of the first and second imaging transducers are configured to generate a plurality of vectors.

25. The system of claim 24, wherein each vector generated by the first imaging transducer has a value that is substantially similar to a vector generated by the second imaging transducer.

26. The system of claim 25, wherein the step of estimating the instantaneous angular velocity comprises:
determining which vector of the second imaging transducer has a value that is substantially similar to a particular vector of the first imaging transducer, and
calculating any discrepancy between the determined vector and an expected vector, wherein the expected vector is a vector of the second imaging transducer that is expected to have a value that is substantially similar to the particular vector of the first imaging transducer.

27. An imaging system comprising:
an imaging catheter having proximal and distal sections;
an imaging device coupled to the distal section of the imaging catheter, said imaging device preferably rotating at a uniform angular velocity; and
a processor configured to generate a plurality of vectors as the imaging device rotates to form a medical image, estimate an instantaneous angular velocity of the imaging device as the imaging device rotates, and remap the plurality of vectors in the event that the estimated instantaneous angular velocity differs from the uniform angular velocity.

28. The imaging system of claim 27, wherein the imaging device comprises a first imaging device and a second imaging device.

29. The imaging system of claim 28, wherein each vector generated by the first imaging device has a value that is substantially similar to a vector generated by the second imaging device.

30. The imaging system of claim 28, wherein the processor
determines which vector of the second imaging device has a value that is substantially similar to a particular vector of the first imaging device, and
calculates any discrepancy between the determined vector and an expected vector, wherein the expected vector is a vector of the second imaging device that is expected to have a value that is substantially similar to the particular vector of the first imaging device.
